(19) United States
(12) Patent Application Publication
(10) Pub. No.: US 2017/0193289 A1
(43) Pub. Date: Jul. 6, 2017

(54) TRANSFORM LIGHTWEIGHT SKELETON AND USING INVERSE KINEMATICS TO PRODUCE ARTICULATE SKELETON

(71) Applicant: Microsoft Technology Licensing, LLC, Redmond, WA (US)

(72) Inventors: Kfir Karmon, Petach-Tikva (IL); Eyal Krupka, Shimshit (IL)

(21) Appl. No.: 14/985,777

(22) Filed: Dec. 31, 2015

(51) Int. Cl. G06K 9/00; G06T 7/00

(52) U.S. Cl. CPC G06K 9/00355; G06T 7/0046; G06T 2207/30008

(57) ABSTRACT

A system of inverse reconstruction of a skeleton model of a hand, comprising: an imager adapted to capture at least one image of a hand; a memory storing a plurality of hand pose features records, each defined by a unique set of discrete pose values; a code store storing a code; at least one processor coupled to the imager, memory and program store for executing the stored code, the code comprising: code instructions to identify a group of discrete pose values from an analysis of the at least one image; code instructions to select a hand pose features record from the hand pose features records according to the group of discrete pose values; and code instructions to reconstruct a skeleton model of the hand in the hand pose from the hand pose features record based on a hand model which maps kinematic characteristics of a plurality of hand organs.

### RELATED APPLICATIONS

This application is related to co-filed, co-pending and co-assigned U.S. patent applications entitled “HAND GESTURE API USING FINITE STATE MACHINE AND GESTURE LANGUAGE DISCRETE VALUES” (Attorney Docket No. 63958), “MULTIMODAL INTERACTION USING A STATE MACHINE AND HAND GESTURES DISCRETE VALUES” (Attorney Docket No. 63959), “RECOGNITION OF HAND POSES BY CLASSIFICATION USING DISCRETE VALUES” (Attorney Docket No. 63960), “STRUCTURE AND TRAINING FOR IMAGE CLASSIFICATION” (Attorney Docket No. 63962), “TRANSLATION OF GESTURE TO GESTURE CODE DESCRIPTION USING DEPTH CAMERA” (Attorney Docket No. 63966), “GESTURES VISUAL BUILDER TOOL” (Attorney Docket No. 63967), “ELECTRICAL DEVICE FOR HAND GESTURES DETECTION” (Attorney Docket No. 63970) and “DETECTION OF HAND GESTURES USING GESTURE LANGUAGE DISCRETE VALUES” (Attorney Docket No. 63971), the disclosures of which are incorporated herein by reference.

### BACKGROUND

The major technological advances of our times in computerized environment have dramatically increased human machine interaction. Traditional human-machine interfaces (HMI) which usually employ input/output devices, such as keyboards, pointing devices and/or touch interfaces may have served the needs of previous times but as HMI becomes highly intense more natural interfaces are desirable. Such natural interfaces may employ one or more different techniques to provide a simple, straight forward, friendly interface to the user while avoiding the use of mediator hardware elements. Furthermore, two or more natural human-machine user interface (NUI) methods may be combined together to provide comprehensive solution allowing a user to simply and/or directly interact with a computerized device, for example, computer, mobile device, computerized machine and/or computerized appliance.

### SUMMARY

According to some embodiments of the present disclosure, there are provided systems and methods for reconstructing a skeleton model of a hand from an image, based on hand poses with discrete values that are identified from the image.

Definition, creation, construction and/or generation of hand gestures, hand poses and/or hand motions as referred to hereinafter throughout this disclosure refers to definition, creation, construction and/or generation of representations of hand gestures, hand poses and hand motions respectively which simulate respective hand gestures, poses and motions of a hand(s).

A dataset stores one or more hand poses wherein each of the one or more hand poses is defined by a features record of discrete values indicating a current state of hand features (characteristics) such as various finger and/or hand states. An image of a hand captured by an imager, such as a camera, is analyzed to find a group of discrete values corresponding to the pose of the hand and the fingers, and a hand pose features record is selected according to the discrete values. A skeleton model of the hand in the pose is reconstructed from the hand features record based on a hand model which maps kinematic characteristics of hand organs, such as bone length and joint movements of fingers. The discrete values are used as input for inverse kinematic algorithm(s) that reconstructs the skeleton model. Optionally, hand motions defined by a features record of discrete values of motion features are also stored in the dataset, and movement of the skeleton model is also reconstructed from a hand motion features record selected based on values of motion features identified from a sequence of the captured images.

By using discrete values the reconstruction of the skeleton model is made simple, avoiding machine learning and computer vision processing in the reconstruction process.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a schematic illustration of an exemplary system for inverse reconstruction of a skeleton model of a hand, according to some embodiments of the present disclosure;

FIG. 2 is a flowchart of an exemplary process for inverse reconstruction of a skeleton model of a hand, according to some embodiments of the present disclosure;

FIG. 3 is a schematic illustration of exemplary hand poses construction, according to some embodiments of the present disclosure;

FIG. 4 is a schematic illustration of an exemplary pinch basic hand pose construction, according to some embodiments of the present disclosure;

FIG. 5 is a schematic illustration of an exemplary basic hand motions construction, according to some embodiments of the present disclosure;

FIG. 6 which is a schematic illustration of an exemplary half circle hand motion construction, according to some embodiments of the present disclosure; and

FIG. 7 is a schematic illustration of an exemplary skeleton model of a hand, according to some embodiments of the present disclosure.

### DETAILED DESCRIPTION

According to some embodiments of the present disclosure, there are provided systems and methods for reconstructing a skeleton model of a hand from an image, based on discrete values which are reconstructed from the image and indicative of states of current hand and finger poses. Using discrete values to identify hand and finger poses by one or more computerized devices provide a fast and low resource way to construct a skeleton model, allowing the use of skeleton models in implementations having for example low central processing unit (CPU) power and/or low memory. A fully detailed skeleton is constructed, using inverse kinematics, by computing low-resource features that force the hand to the actual pose.

A dataset defines a plurality of hand pose features records, each defined by a unique set of discrete values of hand pose features. The hand pose features record may include, for example, a features vector, a features matrix and/or a features table. Optionally, each hand pose features record is defined by one state of a finite state machines (FSM) which includes a finite number of states, each constructed by a set of discrete values. Each hand pose feature represents a specific feature (characteristic) of a hand(s) pose. The pose features may include for example, a hand selection (left, right, both and/or any), a hand rotation, a hand direction, a finger direction (per finger), a finger flex (per finger), a finger tangency (per two or more fingers) and/or a finger relative location (per two or more fingers). Optionally, the dataset also defines a plurality of hand motion features records, each representing a specific feature of the hand(s) motion. The motion features may include for example, motion properties such as, for example, size, speed, range and/or location in space and/or motion script(s) which define the motion shape. The motion script may be defined as a curve in the format of, for example, scalable vector graphics (SVG) and/or a string constructed of one or more pre-defined discrete micro-movements which define micro-movements in each of the three two-dimension (2D) planes. A unique logic sequence of one or more of the hand pose features records and/or hand motion features records may represent one or more hand gestures, for example by a unique finite state machine (FSM) documenting transitions between hand pose(s) and/or hand motion(s).

An imager, such as a camera, captures at least one image of a hand in a current pose, and sends the image to a processor for analysis. The image analysis may include, for example, discriminative fern ensemble (DFE) and/or discriminative tree ensemble (DTE) for identifying the group of discrete pose values representing the hand pose. A hand pose features record is then selected from the dataset, based on the identified group of discrete pose values. Optionally, a set of discrete motion values is identified from a sequence of the captured images and a hand motion features record is selected from the dataset.

A skeleton model of the hand in the pose is reconstructed from the selected hand pose features record. The reconstruction is done based on a hand model which maps kinematic characteristics of each finger, such as a skeleton of rigid segments connected with joints, each representing a finger. The skeleton model defined the spatial location of each part of the hand. Optionally, movement of the skeleton model is also reconstructed from the selected hand motion features record, for example the movement of each segment and each joint of the skeleton.

The skeleton model may be used, for example, to construct a three-dimensional digital image of the hand, for example in virtual reality (VR) and/or augmented reality (AR) uses, for digital animation and/or for interacting with holograms and virtual world objects.

Before explaining at least one embodiment of the exemplary embodiments in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

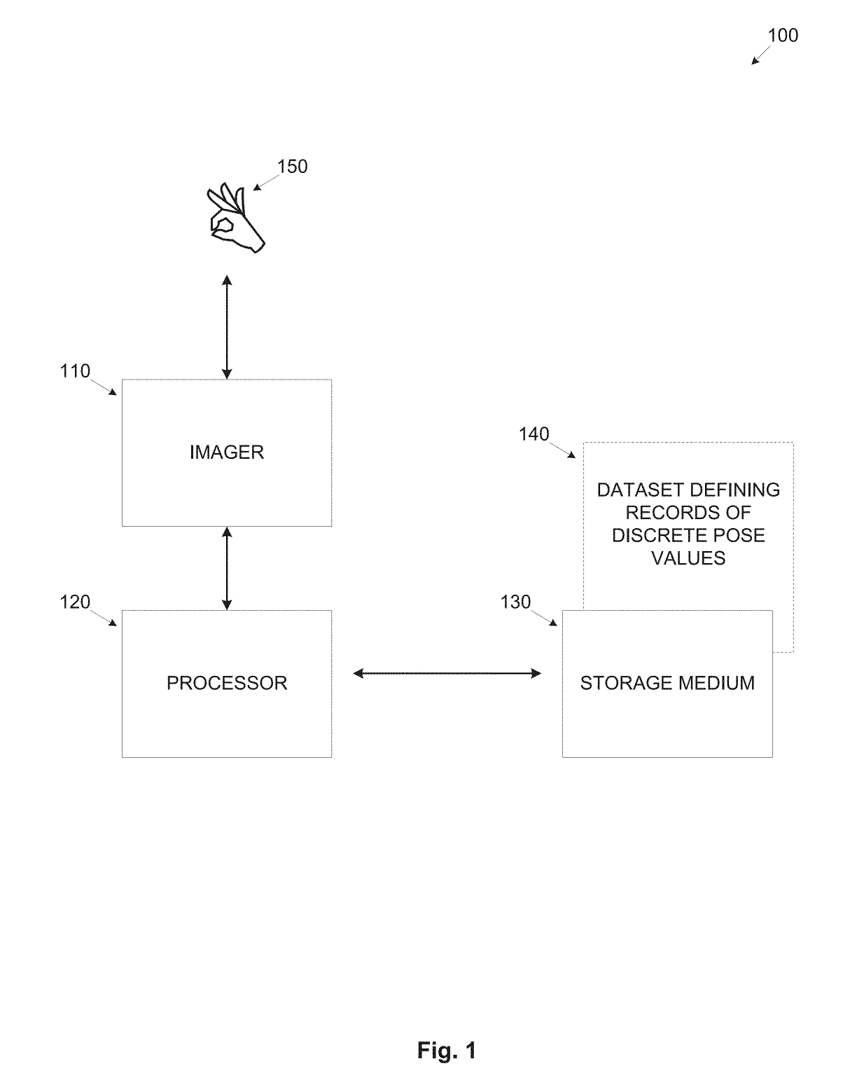

Referring now to the drawings, FIG. 1 is a schematic illustration of an exemplary system for inverse reconstruction of a skeleton model of a hand, according to some embodiments of the present disclosure. An exemplary system 100 includes an imager 110 for capturing at least one image of hand 150, one or more hardware processor(s) 120 and a storage medium 130 for storing the code instructions and a dataset 140 with records defining discrete pose values. System 100 may be included in on one or more computerized devices, for example, computer, mobile device, computerized machine and/or computerized appliance equipped and/or attached to the imager. Hand 150, currently having a hand pose or a sequence of hand poses, may be the hand of a user of the computerized device, for example when using the hand pose to input a command to the computerized device. Imager 110 may include, for example, a color camera, an infra-red (IR) camera, a motion detector, a proximity sensor and/or any other imaging device that captures visual signals or combination thereof. Storage medium 130 may include, for example, a digital data storage unit such as a magnetic drive and/or a solid state drive. Storage medium 130 may also be, for example, a content delivery network or content distribution network (CDN) is a large distributed system of servers deployed in multiple data centers across the Internet.

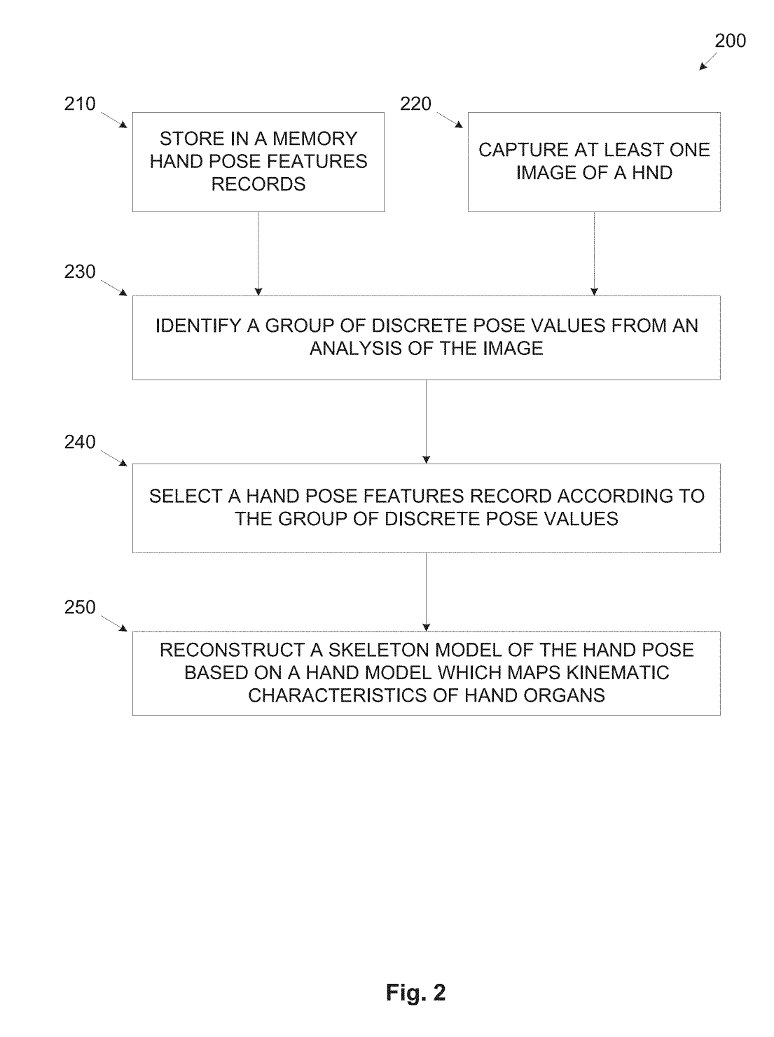

Reference is also made to FIG. 2 which illustrates a flowchart of an exemplary process for inverse reconstruction of a skeleton model of a hand, according to some embodiments of the present disclosure. An exemplary process 200 is executed in a system such as the exemplary system 100.

As shown at 210, a plurality of hand pose features records are stored in dataset 140, each is defined by a unique set of discrete pose values.

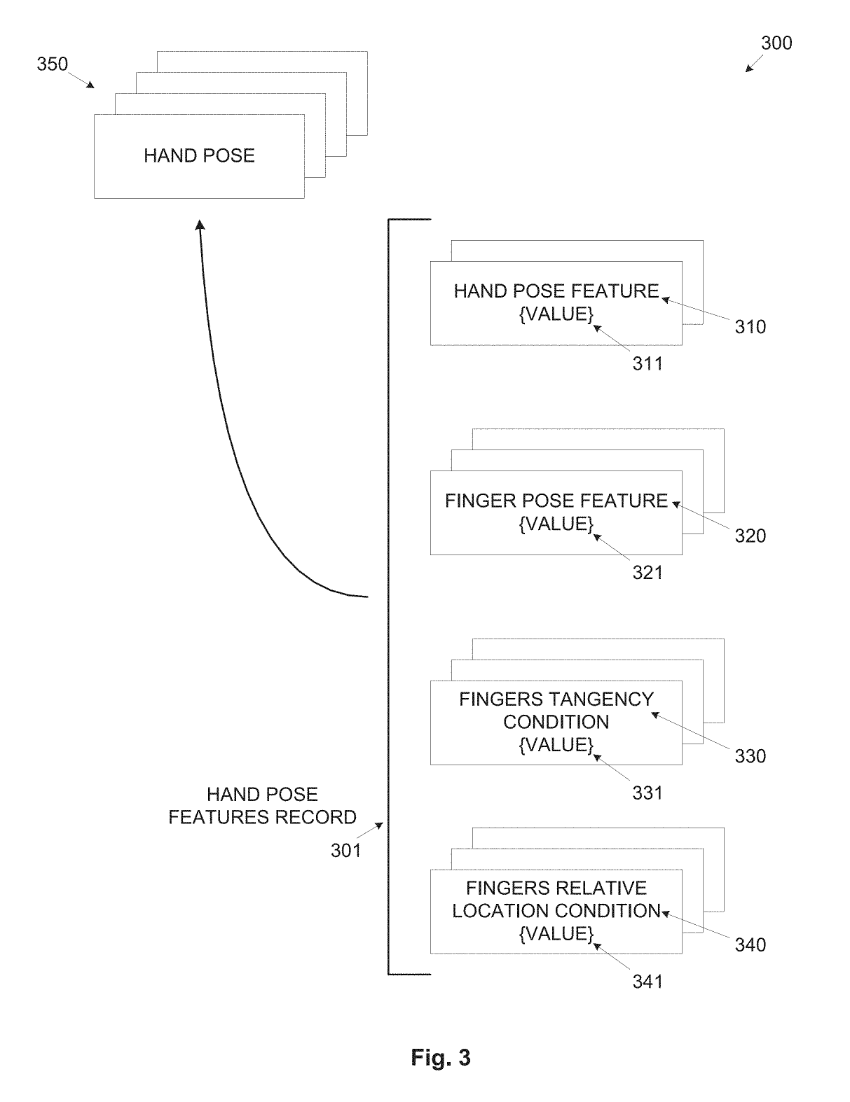

Reference is now made to FIG. 3, which is a schematic illustration of exemplary hand poses construction, according to some embodiments of the present disclosure. Illustration 300 depicts exemplary hand poses construction 350 as a hand pose features record 301 which includes one or more pose features 310, 320, 330 and 340. Each of the pose features may be assigned with one or more discrete pose value 311, 321, 331 and/or 341 which identify the state (value) of the respective pose feature 310, 320, 330 and/or 340 for an associated hand pose of the hand poses 350.

The combination of the one or more discrete pose values 311, 321, 331 and/or 341 of the respective pose features 310, 320, 330 and 340 as defined by the hand pose features record 301 defines a specific pose of the hand poses 350. The hand pose features record 301 may be represented as, for example, a features vector, a features matrix and/or a features table stored in storage medium 130. The hand pose features record 301 may include values of one or more of the following pose features:
Palm pose features—one or more palm pose features 310 include, for example, hand selection, palm direction, palm rotation and/or hand location. Hand selection may identify which hand is active and may include discrete pose values 311 such as, for example, right, left, both and/or any. Palm direction may define the direction in which the palm of the active hand is facing and may include discrete pose values 311 such as, for example, left, right, up, down, forward and/or backward. Palm rotation may define the rotation state of the palm of the active hand and may include discrete pose values 311 such as, for example, left, right, up, down, forward and/or backward. Hand location may identify the spatial location of the active hand in space and may include discrete pose values 311 such as, center of field of view (FOV), right side of FOV, left side of FOV, top of FOV, bottom of FOV, front of FOV and/or rear of FOV. Where FOV is for example, the visible space of an imager 110. Optionally, hand location is identified with respect to a fixed object present in the FOV, for example, keyboard and/or pointing device so that hand location may be defined by discrete pose values 311 such as, for example, above_keybord, behind_keyboard, right_of_keyboard and/or left_of_keyboard.
Finger flexion features—one or more finger flexion features 320 which are defined per finger. For example, a finger flexion feature 320 may be a flexion and/or curve state which may include discrete pose values 321 such as, for example stretched, folded and/or open represented, for example by 0, 1, and 2. Each finger (thumb, index, middle, ring and/or pinky) is assigned one or more specific finger features, for example, {thumb, middle, ring, pinky} in {folded} state and {index} in {stretched} state.
Finger tangency condition features—one or more fingers tangency features 130 which are defined per finger. The tangency feature may define a touch condition of any two or more fingers and/or touch type and may include discrete pose values 331 such as, for example, not touching, fingertip and/or full touch.
Finger relative location condition features—one or more fingers relative location features 340 are defined per finger. Each of the finger relative location condition features 340 may define a relative location of one finger in relation to another. The fingers relative location features 340 may include discrete pose values 341 such as, for example, one or more fingers are located relatively to another one or more fingers to the left, right, above, below, inward, outward, in front and/or behind.

Each one of the hand poses 350 is defined by a unique one of the hand pose features records 301 which may be a combination and/or sequence of one or more discrete pose values 311, 321, 331 and/or 341 each providing a value of the corresponding hand pose feature 310, 320, 330 and/or 340. The hand pose features records 101 may include only some (and not all) of the discrete pose values 311, 321, 331 and/or 341 while other discrete pose values 311, 321, 331 and/or 341 which are not included are left free. For example, the hand pose features records 301 may define a specific state of the fingers (for example discrete pose values 321, 331 and/or 341) while the direction of the hand is left unspecified (for example discrete pose value 311). In this case the hand pose 350 is identified, recognized and/or classified in runtime at the detection of the fingers state as defined by the hand pose features records 301 with the hand facing any direction. Using the discrete pose values 311, 321, 331 and/or 341 allows for simple creation of a hand pose 350 as there are a finite number of discrete pose values 311, 321, 331 and/or 341 with which the hand pose 350 may be created. For instance, the palm rotation feature included in the hand pose feature 310 may include up to six discrete pose values 311—left, right, up, down, forward and backward. The discrete representation of the hand pose features 310, 320, 330 and/or 340 may not be limited to discrete values only. Continuous values of the one or more hand features 310, 320, 330 and/or 340 may be represented by discrete pose values 311, 321, 331 and/or 341 respectively by quantizing the continuous values. For example, the palm rotation palm pose feature may be defined with 8 discrete pose values 311—0°, 45°, 90°, 135°, 180°, 225°, 270° and 315° to quantize the complete rotation range of 0°-360°.

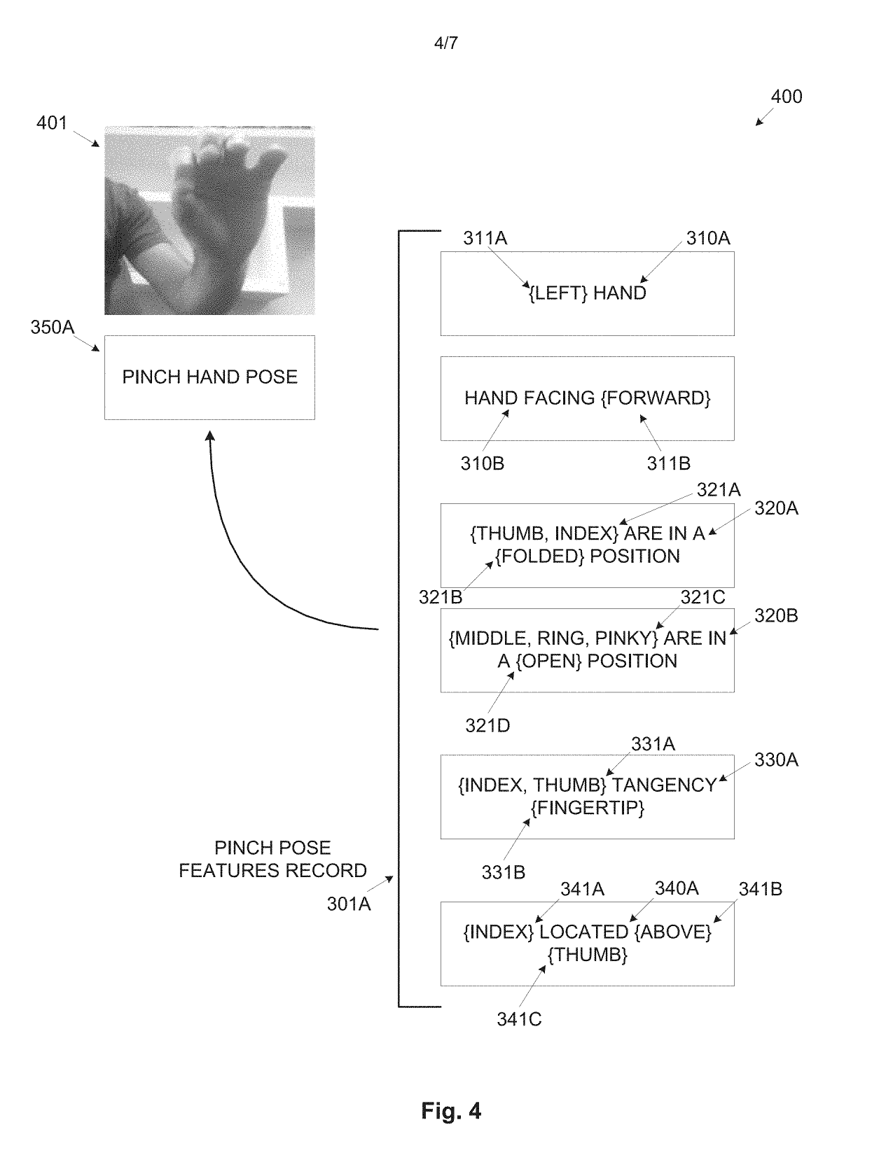

Reference is now made to FIG. 4 which is a schematic illustration of an exemplary pinch basic hand pose construction, according to some embodiments of the present disclosure. Illustration 400 depicts an exemplary pinch hand pose 350A construction by a pinch pose features record 301A comprising discrete pose values such as the discrete pose values 311, 321, 331 and/or 341, each indicating a value of a corresponding hand pose feature such as the pose features 310, 320, 330 and/or 340. The pinch hand pose 350A which is visualized through an image capture 401 is created with some of the plurality of discrete pose values 311, 321, 331 and 341 as follows:
A hand selection feature 310A is assigned a discrete pose value 311A to indicate the left hand is active.
A palm direction feature 310B is assigned a discrete pose value 311B to indicate the palm of the active hand is facing forward.
A fingers flexion feature 320A is assigned a discrete pose value 321A and a discrete flexion value 321B to indicate the thumb and index fingers are folded.
A fingers flexion feature 320B is assigned a discrete pose value 321C and a discrete pose value 321D to indicate the middle, ring and pinky fingers are open.
A fingers tangency condition feature 330A is assigned a discrete pose value 331A to indicate the thumb and index fingers are touching at their tips.
A fingers relative location feature 340A is assigned a discrete pose value 341A, a discrete pose value 341B and a discrete pose value 341C to indicate the index finger is located above the thumb finger.

As seen above, the pinch hand pose 350A is uniquely defined by a pinch pose features record 301A comprising the discrete pose values 311A, 311B, 321A, 321B, 321C, 321D, 331A, 331B, 341A, 341B and 341C corresponding to the hand pose features 310A, 310B, 320A, 320B, 330A and 340A respectively. Similarly additional hand poses may be created using the API and associated with the one or more application functions as indicated by the programmer.

Reference is again made to FIG. 1 and FIG. 2. Optionally, a plurality of hand motion features records are also stored in dataset 140, each is defined by a unique set of discrete motion values.

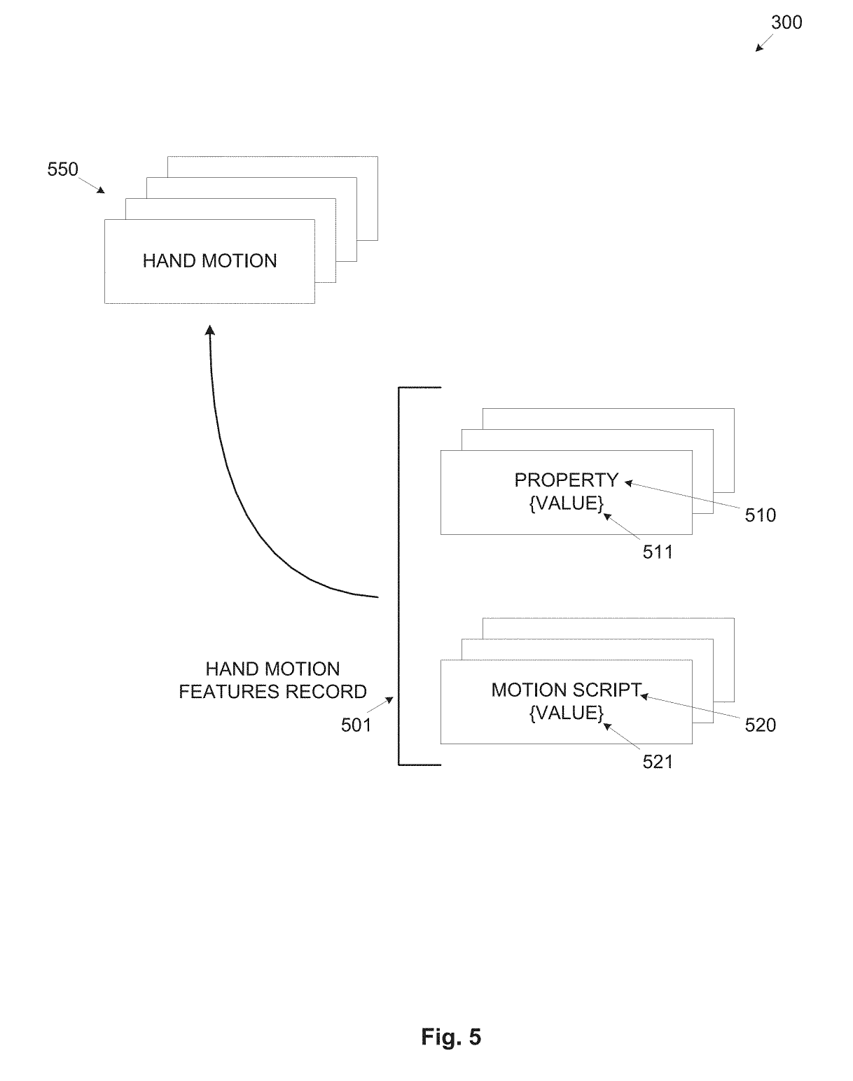

Reference is now made to FIG. 5, which is a schematic illustration of an exemplary basic hand motions construction, according to some embodiments of the present disclosure. Illustration 500 depicts exemplary hand motions 550 construction as a hand motion features record 501 which includes one or more hand motion features 510 and 520. Each of the hand motion features 510 and 520 may be assigned with one or more discrete motion values 511 and/or 521 which identify the state (value) of the respective hand motion feature 510 and/or 520 for an associated hand motion of the hand motions 550. The hand motion features record 501 identifies a specific motion of a hand and/or finger(s) which may later be identified, recognized and/or classified by monitoring the movement of the user's hands. Continuous values of the one or more hand motion features 510 and/or 520 may be represented by the discrete motion values 511 and/or 521 by quantizing the continuous values. The hand motion features record 501 may be represented as, for example, a features vector, a features matrix and/or a features table. The hand motion features record 501 may include one or more of the following hand motion features:
Motion property features—one or more motion property features 510 may include, for example, motion size, motion speed and/or motion location. Motion size may identify the size (scope) of the motion, and may include discrete motion values 511 such as, for example, small, normal and/or large. Motion speed may define the speed of the motion and may include discrete motion values 511 such as, for example, slow, normal, fast and/or abrupt. Motion location may identify the spatial location in which the motion is performed, and may include discrete motion values 511 such as, for example, center of FOV, right side of FOV, left side of FOV, top of FOV, bottom of FOV, front of FOV and/or rear of FOV. Optionally, hand location is identified with respect to a fixed object present in the FOV, for example, keyboard and/or pointing device so that hand location may include discrete motion values 511 such as, for example, above_keybord, behind_keyboard, right_of_keyboard and/or left_of_keyboard.
Motion script features—one or more motion script features 520 may define the actual motion performed. The motion script values 520 may include, for example, motion direction, motion start point, motion end point and/or pre-defined curve shapes.

The motion direction feature 520 may include discreet motion values 521 such as, for example, upward, downward, left_to_right, right_to_left, diagonal_left_upward, diagonal_right_upward, diagonal_left_downward, diagonal_right_downward, clockwise_arc_right_upward, clockwise_arc_right_downward, clockwise_arc_left_upward, clockwise_arc_left_downward, counter_clockwise_arc_right_upward, counter_clockwise_arc_right_downward, counter_clockwise_arc_left_upward and/or counter_clockwise_arc_left_downward. The motion curve shapes may include for example, at-sign (@), infinity sign (∞), digit signs, alphabet signs and the likes. Optionally, additional one or more curve shapes may be created as pre-defined curves, for example, checkmark, bill request and the likes as it is desirable to assign application functions a hand gesture which is intuitive and is publically known, for example, at-sign for composing and/or sending an email, checkmark sign for a check operation and/or a scribble for asking for a bill. The one or more curve shapes may optionally be created using a freehand tool in the format of, for example, SVG. Each of the motion script features 320 is defined for a 2D plane, however each of the motion script features 320 may be transposed to depict another 2D plane, for example, X-Y, X-Z and/or Y-Z. Optionally, the motion script features 320 define three dimensional (3D) motions and/or curves using a 3D image data representation format.

Each one of the hand motions 550 is defined by a unique one of the hand motion features records 501 which may a combination and/or sequence of one or more discrete motion values 511 and/or 521 each providing a value of the corresponding hand motion feature 510 and/or 520. Using the discrete motion values 521 and/or 521 allows for simple creation of the hand motions 550 as there are a finite number of discrete motion values 511 and/or 521 with which the hand motion 550 may be created. For instance the motion speed feature included in the hand motion property feature 510 may include up to four discrete motion values 511—slow, normal, fast and abrupt. The discrete representation of the hand motion features 510 and/or 520 may not be limited to discrete values only, continuous values of the one or more hand motion features 510 and/or 520 may be represented by discrete motion values 511 and/or 521 respectively by quantizing the continuous values. For example, the motion speed motion property feature may be defined with 6 discrete motion values 511—5 m/s (meter/second), 10 m/s, 15 m/s, 20 m/s, 25 m/s and 30 m/s to quantize the motion speed of a normal human hand of 0 m/s-30 m/s.

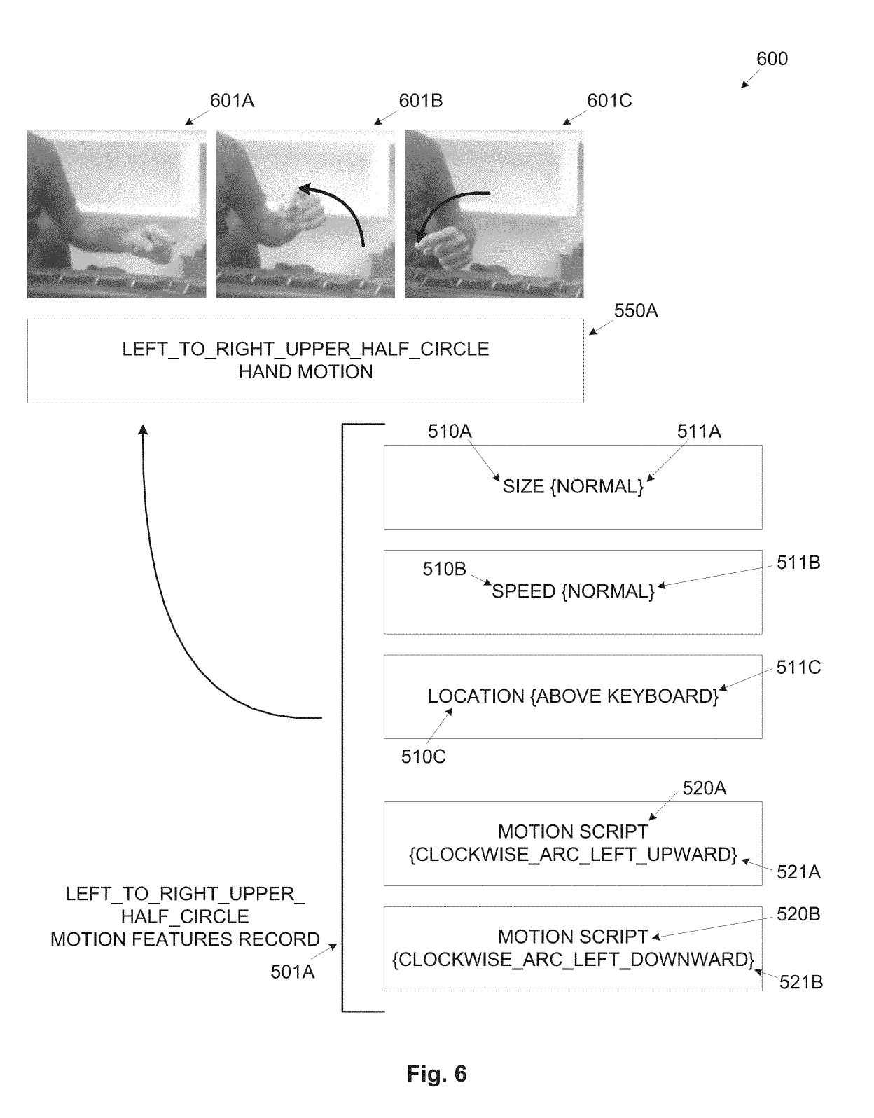

Reference is now made to FIG. 6 which is a schematic illustration of an exemplary half circle hand motion construction, according to some embodiments of the present disclosure. Illustration 600 depicts an exemplary left_to_right_upper_half circle hand motion 550A construction by a left_to_right_upper_half circle hand motion features record 501A comprising discrete motion values such as the discrete motion values 511 and/or 521, each indicating a corresponding hand motion feature such as the hand motion features 510 and/or 520. The left_to_right_upper_half_circle hand motion 550A which is visualized through image captures 601A, 601B and 601C is created with some of the plurality of discrete motion values 511 and 521 as follows:
A motion size feature 510A is assigned a discrete motion value 511A to indicate the motion size is normal.
A motion speed feature 510B is assigned a discrete motion value 511B to indicate the motion speed is normal.
A motion location feature 510C is assigned a discrete motion value 511C to indicate the motion is performed above a keyboard.
A first motion script feature 520A is assigned a discrete motion value 521A to indicate a motion shape of clockwise_arc_left_upward as presented by the image capture 601B.
A second motion script feature 520B is assigned a discrete motion value 521B to indicate a motion shape of clockwise_arc_left_downward as presented by the image capture 601C.

As seen above, the left_to_right_upper_half_circle hand motion 550A is uniquely defined by a left_to_right_upper_half_circle hand motion features record 501A comprising of the discrete motion values 511A, 511B, 511C, 521A and 521B corresponding to the motion features 510A, 510B, 510C, 520A and 520B respectively. Similarly additional hand and/or finger(s) motion may be created using the API and associated with the one or more application functions as indicated by the programmer.

Reference is again made to FIG. 1 and FIG. 2. As shown at 220, at least one image of a hand 150 is captured by imager 110. Optionally, a sequence of images, such as a video, is captured, which depict a movement of hand 150.

Then, as shown at 230, the image(s) is analyzed by processor(s) 120 and a group of discrete pose values is identified, as described above. Optionally, a sequence of images is analyzed and a set of discrete motion values is also identified, as described above. The analysis may include, for example, discriminative fern ensemble (DFE), discriminative tree ensemble (DTE) and/or any other image processing algorithm and/or method.

Then, as shown at 240, a hand pose features record is selected by processor(s) 120 from the plurality of hand pose features records stored in dataset 140, according to the group of discrete pose values identified by the analysis from the image(s). Optionally, when a discrete motion values is also identified a hand motion features record is selected from the plurality of hand motion features records stored in dataset 140, according to the group of discrete motion values identified by the analysis. The selection may be done, for example, by using matching algorithm(s) between the identified values and the values stored in dataset 140 for each features record. Recognition, identification and/or classification of the one or more hand poses 350 and/or one or more hand motions 550 is simpler than other image recognition processes of hand poses and/or motions, since the discrete pose values 311, 321, 331 and/or 341 and/or the discrete motion values 511 and/or 521 are easily identified because there is no need for hand skeleton modeling during recognition, identification and/or classification, thus reducing the level of computer vision processing. Furthermore, use of computer learning and/or three dimensional vector processing is completely avoided during skeleton reconstruction as the one or more hand poses 350 and/or one or more hand motions 550 are identified, recognized and/or classified using a gesture library and/or a gesture API which may be trained in advance. Training of the gesture library and/or gesture API may be greatly simplified thus reducing the processing load, due to the discrete construction of the hand poses 350 and/or hand motions 550 which allows for a finite, limited number of possible states for each of the pose features 310, 320, 330 and/or 340 and/or each of the motion features 510 and 520.

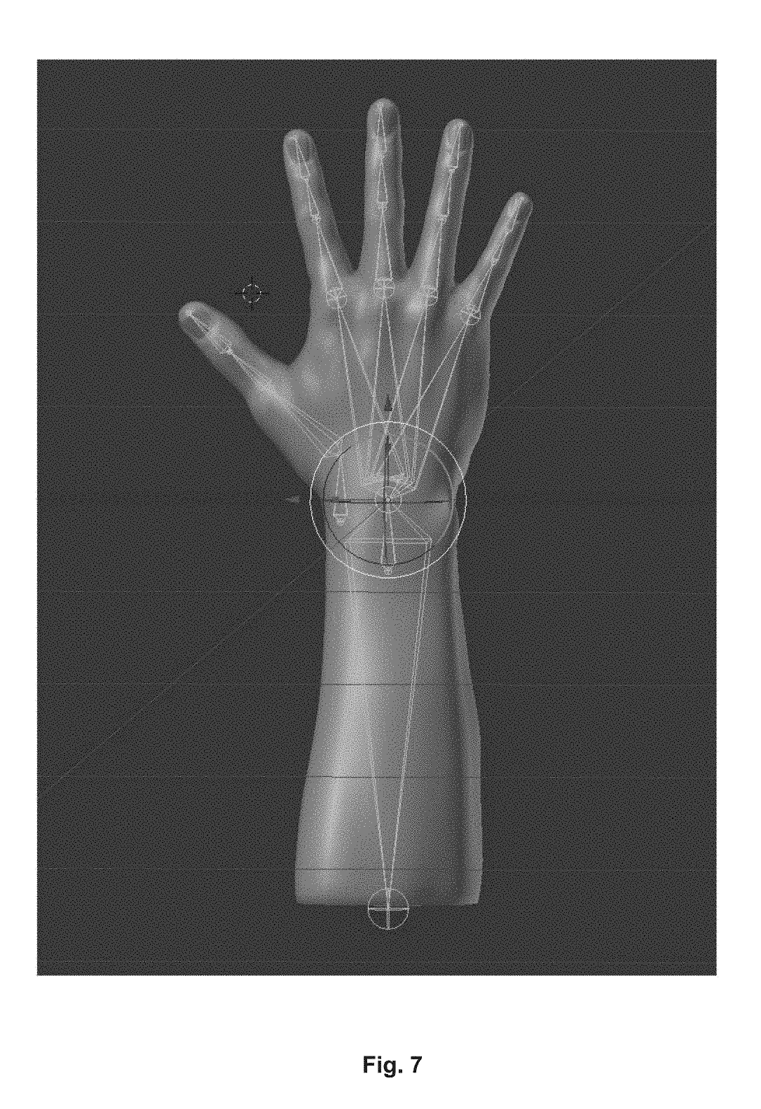

Finally, as shown at 250, a skeleton model of hand 150 in the hand pose is reconstructed by processor(s) 120 from the selected hand pose features record. Reference is made to FIG. 7 which is a schematic illustration of an exemplary skeleton model of a hand, according to some embodiments of the present disclosure. For example, the skeleton model may be a virtual three dimensional skeleton of rigid segments connected with joints, where each segment is representing a bone in hand 150 and each joint is representing a bone joint in hand 150, and defines their spatial location. Optionally, movement of the skeleton model is also reconstructed by processor(s) 120 from the selected hand motion features record. For example, movement of the fingers of hand 150 is represented by motion of the segments and joints of the skeleton.

The hand pose features record (or light weight skeleton) is cheap to compute but poses strong constraints on the physics of the hand Given the hand's physical properties, such as length of bones that may be detected and/or estimated using the captured image(s), the actual high resolution skeleton model may be deduced with high accuracy. This high resolution skeleton model is harder to deduce directly from an image due to its complexity.

The reconstruction is done based on a hand model which maps kinematic characteristics of hand organs, such as bone length and joint movements of fingers. For example, the hand model may be based on inverse kinematics, which uses the kinematics equations to determine the joint parameters that provide the pose of hand 150. The kinematics equations of the hand define the relationship between the joint angles of the hand and its pose or configuration. Inverse kinematics algorithms solves a system of equations that model the possible configurations of the joints of the hand skeleton and acts as a constraint to each joint's freedom of movement. Inverse kinematics algorithms may calculate possible locations of hand organs given some hand pose features, such as the location of fingers, their positions, orientation and/or relative position. For example, given the discrete pose values 311, 321, 331 and/or 341, potential reconstructions of a skeleton model may be calculated.

For example, reconstructing a skeleton model the exemplary pinch hand pose 350A, the discrete pose values 311A, 311B, 321A, 321B, 321C, 321D, 331A, 331B, 341A, 341B and 341C are used as input for an inverse kinematics algorithm. Based on these discrete pose values, the inverse kinematics algorithm may reconstruct a skeleton model or a potential skeleton model of the hand in the exemplary pinch hand pose 350A. For example, the position of the joints of the thumb may be deduced by the algorithm based on discrete pose values 311A and 311B indicating the hand is a left hand facing forward, on discrete pose value 321B indicating the thumb is in folded position and on discrete pose value 331A that indicates that the thumb touches the index finger at their tips. Also, for example, for reconstructing movement of the skeleton model in the exemplary half circle hand motion 550A, the discrete motion values 511A, 511B, 511C, 521A and 521B are used as input for an inverse kinematics algorithm. For example, the movement of the joints of the thumb may be deduced by the algorithm based on the trajectory of the hand.

The modeling and/or solving of inverse kinematics may be done, for example, by using regression algorithms, Jacobian inverse and/or methods that rely on iterative optimization. The skeleton model may be used, for example, to present a hand in a virtual reality (VR) and/or augmented reality (AR) systems. For example, when a hand of a user is imaged, identified and modeled into features record(s), a skeleton model may be reconstructed and used as a basis for a virtual hand presented to the user. The skeleton model may also be used, for example, for creating life-like movements in hand animation, for example based on a video of a hand.

It is expected that during the life of a patent maturing from this application many relevant systems and methods for reconstructing a skeleton model will be developed and the scope of the term skeleton model is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

According to an aspect of some embodiments of the present invention there is provided a system of inverse reconstruction of a skeleton model of a hand, comprising: an imager adapted to capture at least one image of a hand; a memory storing a plurality of hand pose features records, each one of the plurality of hand pose features records being defined by a unique set of discrete pose values; a code store storing a code; at least one processor coupled to the imager, the memory and the program store for executing the stored code, the code comprising: code instructions to identify a group of discrete pose values from an analysis of the at least one image; code instructions to select a hand pose features record from the plurality of hand pose features records according to the group of discrete pose values; and code instructions to reconstruct a skeleton model of the hand in the hand pose from the hand pose features record based on a hand model which maps kinematic characteristics of a plurality of hand organs.

Optionally, the hand pose feature is a member selected from a group comprising of: active hand, hand direction, hand rotation, pose of at least one finger, relative location between at least two fingers and tangency between at least two fingers.

Optionally, the system further comprises: the memory is further storing a plurality of hand motion features records, each one of the plurality of hand motion features records being defined by a unique set of discrete motion values; and the code is further comprising: code instructions to identify a set of discrete motion values from an analysis of a sequence of the at least one image which depict a movement of the hand; code instructions to select a hand motion features record from the plurality of hand motion features records according to the group of discrete motion values; and code instructions to reconstruct movement of the skeleton model from the hand motion features record.

More optionally, the hand motion feature is a member selected from a group comprising of: motion properties and motion script, the motion script defines at least one of: hand motion and motion of at least one finger.

Optionally, the unique set of discrete pose values being defined by a unique finite state machine model.

Optionally, the skeleton model being used to present a hand in at least one of virtual reality (VR) system and augmented reality (AR) system.

Optionally, the skeleton model being used for creating hand animation.

According to an aspect of some embodiments of the present invention there is provided a method for inverse reconstruction of a skeleton model of a hand, comprising: storing in a memory a plurality of hand pose features records, each one of the plurality of hand pose features records being defined by a unique set of discrete pose values; capturing at least one image of a hand by an imager; identifying a group of discrete pose values from an analysis of the at least one image; selecting a hand pose features record from the plurality of hand pose features records according to the group of discrete pose values; and reconstructing a skeleton model of the hand in the hand pose from the hand pose features record based on a hand model which maps kinematic characteristics of a plurality of hand organs.

Optionally, the hand pose feature is a member selected from a group comprising of: active hand, hand direction, hand rotation, pose of at least one finger, relative location between at least two fingers and tangency between at least two fingers.

Optionally, the method further comprises: storing in the memory a plurality of hand motion features records, each one of the plurality of hand motion features records being defined by a unique set of discrete motion values; identifying a set of discrete motion values from an analysis of a sequence of the at least one image which depict a movement of the hand; selecting a hand motion features record from the plurality of hand motion features records according to the group of discrete motion values; and reconstructing movement of the skeleton model from the hand motion features record.

More optionally, the hand motion feature is a member selected from a group comprising of: motion properties and motion script, the motion script defines at least one of: hand motion and motion of at least one finger.

Optionally, the unique set of discrete pose values being defined by a unique finite state machine model.

Optionally, the skeleton model being used to present a hand in at least one of virtual reality (VR) system and augmented reality (AR) system.

Optionally, the skeleton model being used for creating hand animation.

According to an aspect of some embodiments of the present invention there is provided a software program product for inverse reconstruction of a skeleton model of a hand, comprising: a non-transitory computer readable storage medium; first program instructions for receiving at least one image of a hand captured by an imager; second program instructions for accessing a memory storing a plurality of hand pose features records, each one of the plurality of hand pose features records being defined by a unique set of discrete pose values; third program instructions for identifying a group of discrete pose values from an analysis of the at least one image; fourth program instructions for selecting a hand pose features record from the plurality of hand pose features records according to the group of discrete pose values; and fifth program instructions for reconstructing a skeleton model of the hand in the hand pose from the hand pose features record based on a hand model which maps kinematic characteristics of a plurality of hand organs; wherein the first, second, third, fourth, and fifth program instructions are executed by at least one computerized processor from the non-transitory computer readable storage medium.

Optionally, the hand pose feature is a member selected from a group comprising of: active hand, hand direction, hand rotation, pose of at least one finger, relative location between at least two fingers and tangency between at least two fingers.

Optionally, the memory is further storing a plurality of hand motion features records, each one of the plurality of hand motion features records being defined by a unique set of discrete motion values; and the software program product is further comprising: sixth program instructions for identifying a set of discrete motion values from an analysis of a sequence of the at least one image which depict a movement of the hand; seventh program instructions for selecting a hand motion features record from the plurality of hand motion features records according to the group of discrete motion values; and eighth program instructions for reconstructing movement of the skeleton model from the hand motion features record; wherein the sixth seventh and eighth program instructions are executed by the at least one computerized processor.

More optionally, wherein the hand motion feature is a member selected from a group comprising of: motion properties and motion script, the motion script defines at least one of: hand motion and motion of at least one finger.

Optionally, the unique set of discrete pose values being defined by a unique finite state machine model.

Optionally, the skeleton model being used to present a hand in at least one of virtual reality (VR) system and augmented reality (AR) system.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A system of inverse reconstruction of a skeleton model of a hand, comprising:
an imager adapted to capture at least one image of a hand in a hand pose;
a memory storing a plurality of hand pose features records, each one of said plurality of hand pose features records being defined by a unique set of discrete pose values;
a code store storing a code;
at least one processor coupled to said imager, said memory and the program store for executing said stored code, said code comprising:
code instructions to identify a group of discrete pose values from an analysis of said at least one image;
code instructions to select a hand pose features record from said plurality of hand pose features records according to said group of discrete pose values; and
code instructions to reconstruct a skeleton model of said hand in said hand pose from said hand pose features record based on a hand model which maps kinematic characteristics of a plurality of hand organs.

2. The system of claim 1, wherein said hand pose feature is a member selected from a group comprising of: active hand, hand direction, hand rotation, pose of at least one finger, relative location between at least two fingers and tangency between at least two fingers.

3. The system of claim 1, wherein:
said memory is further storing a plurality of hand motion features records, each one of said plurality of hand motion features records being defined by a unique set of discrete motion values; and
said code is further comprising:
code instructions to identify a set of discrete motion values from an analysis of a sequence of said at least one image which depict a movement of said hand;
code instructions to select a hand motion features record from said plurality of hand motion features records according to said group of discrete motion values; and
code instructions to reconstruct movement of said skeleton model from said hand motion features record.

4. The system of claim 3, wherein said hand motion feature is a member selected from a group comprising of: motion properties and motion script, said motion script defines at least one of: hand motion and motion of at least one finger.

5. The system of claim 1, wherein said unique set of discrete pose values being defined by a unique finite state machine model.

6. The system of claim 1, wherein said skeleton model being used to present a hand in at least one of virtual reality (VR) system and augmented reality (AR) system.

7. The system of claim 1, wherein said skeleton model being used for creating hand animation.

8. A method for inverse reconstruction of a skeleton model of a hand, comprising:
storing in a memory a plurality of hand pose features records, each one of said plurality of hand pose features records being defined by a unique set of discrete pose values;
capturing at least one image of a hand in a hand pose by an imager;
identifying a group of discrete pose values from an analysis of said at least one image;
selecting a hand pose features record from said plurality of hand pose features records according to said group of discrete pose values; and
reconstructing a skeleton model of said hand in said hand pose from said hand pose features record based on a hand model which maps kinematic characteristics of a plurality of hand organs.

9. The method of claim 8, wherein said hand pose feature is a member selected from a group comprising of: active hand, hand direction, hand rotation, pose of at least one finger, relative location between at least two fingers and tangency between at least two fingers.

10. The method of claim 8, further comprising:
storing in said memory a plurality of hand motion features records, each one of said plurality of hand motion features records being defined by a unique set of discrete motion values;
identifying a set of discrete motion values from an analysis of a sequence of said at least one image which depict a movement of said hand;
selecting a hand motion features record from said plurality of hand motion features records according to said group of discrete motion values; and
reconstructing movement of said skeleton model from said hand motion features record.

11. The method of claim 10, wherein said hand motion feature is a member selected from a group comprising of: motion properties and motion script, said motion script defines at least one of: hand motion and motion of at least one finger.

12. The method of claim 8, wherein said unique set of discrete pose values being defined by a unique finite state machine model.

13. The method of claim 8, wherein said skeleton model being used to present a hand in at least one of virtual reality (VR) system and augmented reality (AR) system.

14. The method of claim 8, wherein said skeleton model being used for creating hand animation.

15. A software program product for inverse reconstruction of a skeleton model of a hand, comprising:
a non-transitory computer readable storage medium;
first program instructions for receiving at least one image of a hand in a hand pose captured by an imager;
second program instructions for accessing a memory storing a plurality of hand pose features records, each one of said plurality of hand pose features records being defined by a unique set of discrete pose values;
third program instructions for identifying a group of discrete pose values from an analysis of said at least one image;
fourth program instructions for selecting a hand pose features record from said plurality of hand pose features records according to said group of discrete pose values; and
fifth program instructions for reconstructing a skeleton model of said hand in said hand pose from said hand pose features record based on a hand model which maps kinematic characteristics of a plurality of hand organs;
wherein said first, second, third, fourth, and fifth program instructions are executed by at least one computerized processor from said non-transitory computer readable storage medium.

16. The software program product of claim 15, wherein said hand pose feature is a member selected from a group comprising of: active hand, hand direction, hand rotation, pose of at least one finger, relative location between at least two fingers and tangency between at least two fingers.

17. The software program product of claim 15, wherein:
said memory is further storing a plurality of hand motion features records, each one of said plurality of hand motion features records being defined by a unique set of discrete motion values; and
said software program product is further comprising:
sixth program instructions for identifying a set of discrete motion values from an analysis of a sequence of said at least one image which depict a movement of said hand;
seventh program instructions for selecting a hand motion features record from said plurality of hand motion features records according to said group of discrete motion values; and
eighth program instructions for reconstructing movement of said skeleton model from said hand motion features record;
wherein said sixth seventh and eighth program instructions are executed by said at least one computerized processor.

18. The software program product of claim 17, wherein said hand motion feature is a member selected from a group comprising of: motion properties and motion script, said motion script defines at least one of: hand motion and motion of at least one finger.

19. The software program product of claim 15, wherein said unique set of discrete pose values being defined by a unique finite state machine model.

20. The software program product of claim 15, wherein said skeleton model being used to present a hand in at least one of virtual reality (VR) system and augmented reality (AR) system.
